(19) United States
(12) Patent Application Publication
(10) Pub. No.: US 2004/0164914 A1
(43) Pub. Date: Aug. 26, 2004

(54) Enveloped type multi-frequency antenna

(75) Inventor: Hunter Sue, Kaoshsiung (TW)

Correspondence Address: BRUCE H. TROXELL, SUITE 1404, 5205 LEESBURG PIKE, FALLS CHURCH, VA, 22041, US

(73) Assignee: INPAQ TECHNOLOGY CO., LTD.

(21) Appl. No.: 10/434,239

(22) Filed: May 9, 2003

(30) Foreign Application Priority Data
Feb. 20, 2003 (TW) 092202641

(51) Int. Cl. H01Q 21/00; H01Q 1/36

(52) U.S. Cl. 343/725; 343/895

(57) ABSTRACT

Disclosed herein is an enveloped type multi-frequency antenna comprising a helically wound antenna conductor and a plate type antenna conductor, wherein the former is enclosed over the latter so as to respectively respond to different frequency bands. The plate type antenna conductor may also serve as a supporting stem such that the overall length of the antenna is shortened which leads to reducing the fabrication cost of the antenna.

### BACKGROUND OF THE INVENTION

1. Field of the Invention

The present invention relates to an enveloped type multi-frequency antenna, and in particular, to an antenna which is composed of a helically wound conductor and a plate type conductor, and the former is enveloped over the latter so as to enable the antenna operatable against various frequency bands.

2. Description of the Prior Art

As it is well known, an antenna plays an important role on the communication engineering. If it had not been for an antenna, transmission and reception of communication signals would have become impossible, and electronic technology would have lost its playground.

A well-known stub antenna emerged out of a cellular phone housing 100 is shown in FIGS. 1 and 2. An essential part, all antenna body 200 is, as shown in FIG. 2, made of a helically wound wire conductor, which is further sectioned into two or more than two sections L1, L2, . . . The pitches P1, P2 . . . of two successive L1, L2 helically wound wire conductors make the antenna applicable for multi-frequency band communication.

A stub 300 is fitted into the hollow fuselage of the antenna body 200 therefore increasing the extra cost of the stub 300, moreover, the cascade connection of the helically wound wire conductors L1, L2 . . . results in increasing the height and the fabrication cost of the antenna.

In order to solve the above-described problems, the present inventor has carried out theoretical studies and simulating experiments, and based on these studies and researches, the present inventor has come to propose the present invention.

### SUMMARY OF THE INVENTION

Accordingly, the main object of the present invention is to provide an enveloped type multi-frequency antenna whose main body is composed of two sections in which one of the two is enveloped by the other, and the inner one may also serve as a supporting stem in addition to its regular function as an antenna so as to shorten the length of antenna and reduce the fabrication cost of the antenna.

To achieve the aforesaid object, the antenna of the present invention comprises a helically wound antenna conductor and a plate type antenna conductor, the former is formed with helically wound wires, while the latter is formed by printing an antenna conductor pattern on a plate substrate. The base part of the antenna conductor pattern is formed with several protuberances. The helically wound antenna conductor pattern is formed with several protuberances. The helically wound antenna conductor is enveloped over the plate type antenna conductor and the two antenna conductors are connected together by contacting their base parts with each other thereby forming a multi-frequency antenna consisting of two antenna sections. The length of the helically wound antenna conductor is in a defined relationship with a specific frequency band; while the antenna conductor pattern of the plate type antenna conductor is in a defined relationship with another specific frequency band.

### BRIEF DESCRIPTION OF THE DRAWINGS

The accompanying drawings, which are included to provide a further understanding of the invention and incorporated in and constitute a part of this specification, illustrate embodiments of the invention and together with the description serve to explain the principles of the invention, in which:

FIG. 1 is a schematic view of a conventional cellular phone and its antenna.

FIG. 2 is a schematic view showing the antenna construction inside the housing of the cellular phone shown in FIG. 1;

FIG. 3 is a schematic view of the enveloped type multi-frequency antenna according to the present invention;

FIG. 4 is a schematic view of the plate type antenna conductor according to the present invention;

FIG. 5 is a schematic view of the plate type antenna conductor in another embodiment of the present invention;

FIG. 6 is a schematic view in which the helically wound antenna conductor is enclosed over, and connected with the plate type antenna conductor of FIG. 5 to form a complete multi-frequency antenna of the present invention; and

FIG. 7 is a schematic view showing the antenna of the present invention is accommodated in a housing of a cellular phone.

### DETAILED DESCRIPTION OF THE PREFERRED EMBODIMENTS

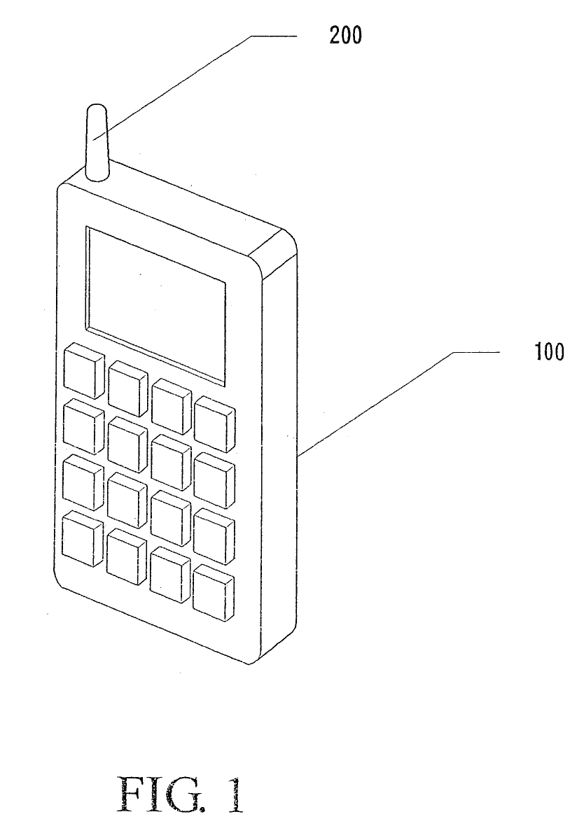

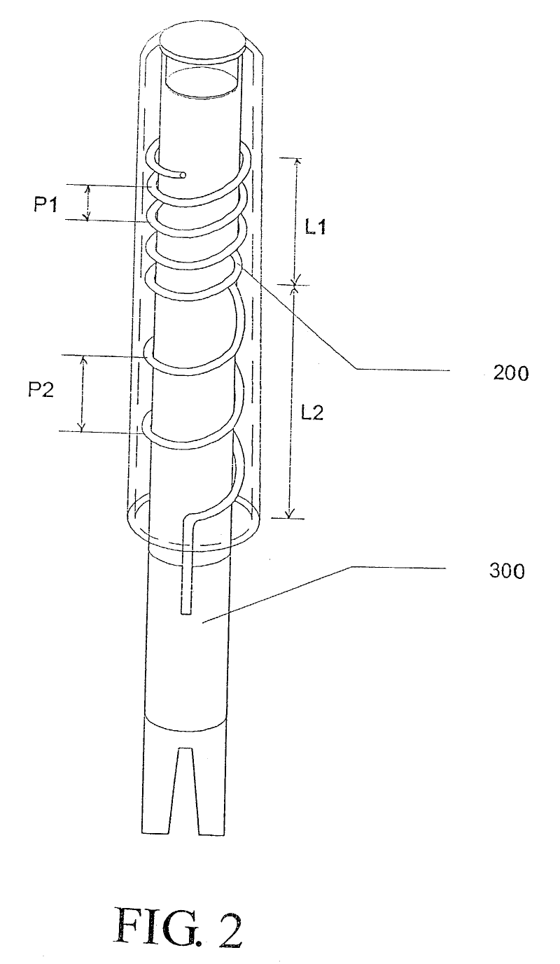

FIGS. 1 and 2 are schematic views of a cellular phone with its affixed antenna whose structural characteristic has been illustrated and thus will not be repeated herein.

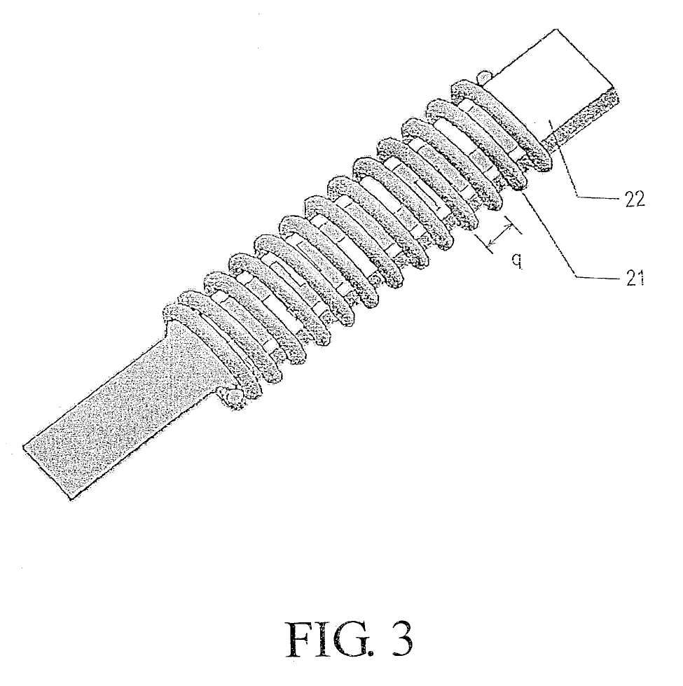

FIG. 3 shows a schematic view of the antenna of the present invention. It is clearly seen that the antenna of the present invention essentially comprises a helically wound antenna conductor 21, and a plate type antenna conductor 22.

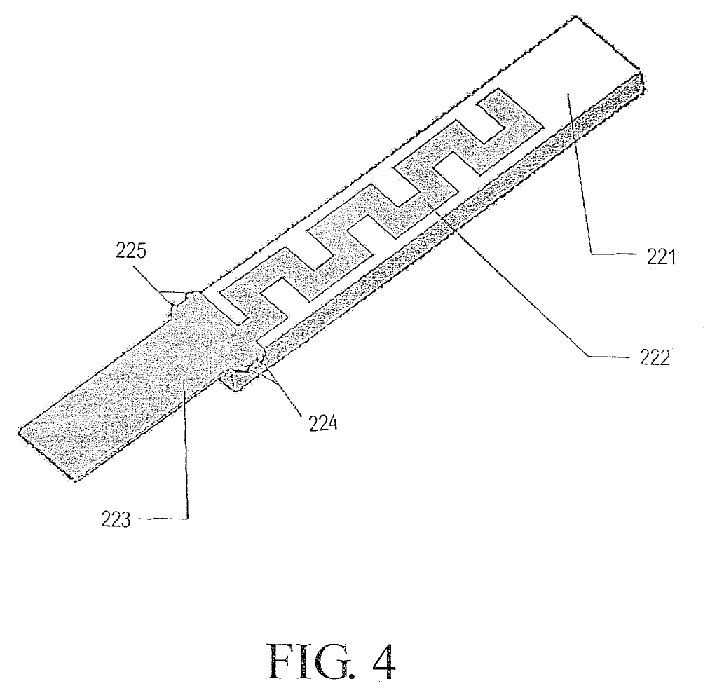

The pitch length of the helically wound antenna conductor 21 is in a defined relationship with a specific frequency band. The plate type antenna conductor 22 shown in FIG. 4 is preferably a meandering antenna conductor pattern 222 printed on a substrate 221, and the length of the pattern 222 is in a defined relationship with another specific frequency band. There is an extension portion emerged out of the base part of the pattern 222 to connect with the communication system. Besides, protuberances 224, 225 are formed on the base part of the pattern 222.

Again, returning to FIG. 3, the helically wound antenna conductor 21 is enveloped over the plate type antenna conductor 22 and the two antenna conductors 21, 22 are connected together by contacting their base parts with each other thereby forming a multi-frequency antenna consisting of two antenna sections, e.g. the conductors 21 and 22.

Referring once again to FIG. 3, since the substrate 221 of the plate type antenna conductor 22 is made of an insulation material, and the helically wound antenna conductor 21 in touch with the substrate 221 does not come to touch the antenna conductor 222 formed on the substrate 221, with this arrangement, the plate type antenna conductor 22 call also serve as a supporting stem for the helically wound antenna conductor 21. As a result, the two antenna conductors 21, 22 are superposed to greatly shorten the overall antenna length thereby remarkably cutting down the fabrication cost of the antenna of the present invention.

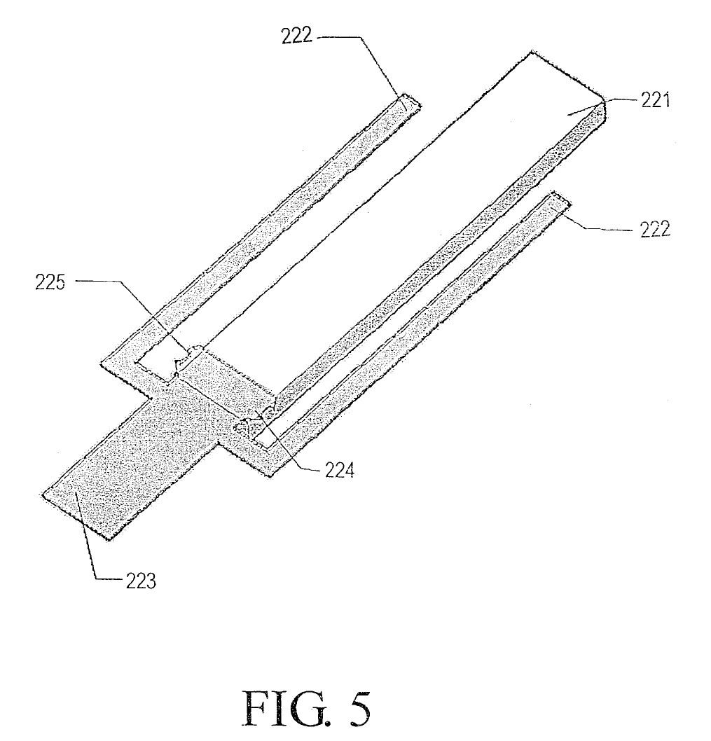

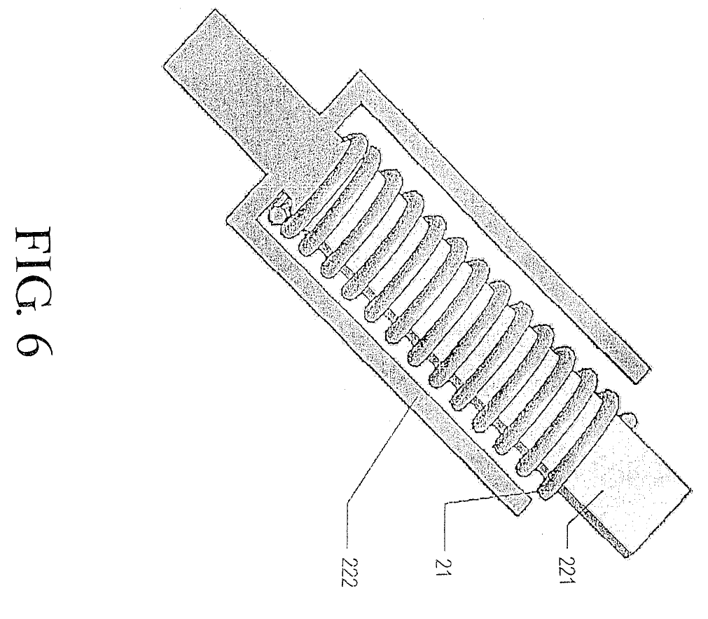

In another embodiment of the present invention shown in FIGS. 5 and 6, the antenna pattern 222 of the plate type antenna conductor 22 is emerged outside of, and along the substrate 221, and an extended portion 223 of the antenna pattern 222 together with two protuberances 224, 225 is formed at the base part of the substrate 221 as shown in FIG. 5.

With such a structure, the base part of the helically wound antenna conductor 21 is hooked onto the protuberances 224, 225 so that its base part is also brought to contact the base part of the antenna pattern 222 when the antenna conductor 21 is fitted over the substrate 221. The entire antenna is therefore constructed in a multi-frequency communication purpose as shown in FIG. 6.

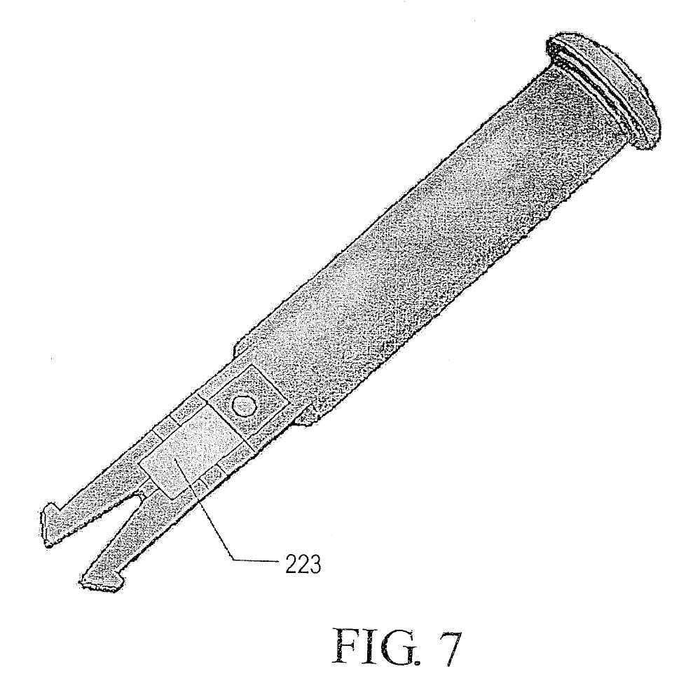

FIG. 7 shows the antenna of the present invention is put away in a housing of a cellular phone. Apparently, it is constructed more compact and shorter than a conventional one.

From the above description, it is obvious that the merit of the present invention exists in its ingeniously constructed structure by enveloping the helically wound antenna conductor over the plate type antenna conductor so as to shorten the length of an antenna and reduce its fabrication cost without affecting its workability against multi-frequency communication.

What is claimed is:

1. Enveloped type multi-frequency antenna comprising:
A helically wound antenna conductor and a plate type antenna conductor; the former being formed with helically wound wires, while the latter being formed by printing an antenna conductor pattern on a plate substrate, wherein the base part of said antenna conductor pattern is provided with several protuberances, said helically wound antenna conductor is enveloped over said plate type antenna conductor and said two antenna conductors are connected together by contacting their base parts with each other thereby forming a multi-frequency antenna consisting of two antenna sections.

2. The antenna as in claim 1, wherein the length of said helically wound antenna conductor is in a defined relationship with a specific frequency band; while said antenna conductor pattern of said plate type antenna conductor is in a defined relationship with another specific frequency band.

3. The antenna as in claim 1, wherein said plate type antenna conductor is formed with a plate conductor.

4. The antenna as in claim 3, wherein said plate type antenna conductor is made of an insulation plate enclosed over by said helically wound antenna conductor, and more than one piece of plate conductors are connected with the base part of said helically wound antenna conductor.

5. The antenna as in claim 4, wherein the plate conductor of said plate type antenna conductor is provided with several protuberances to be engaged with corresponding protuberances formed on the base part of said helically wound antenna conductor.
